(19) United States
(12) Patent Application Publication
(10) Pub. No.: US 2023/0314170 A1
(43) Pub. Date: Oct. 5, 2023

(54) METHOD FOR CREATING MAP DATA

(71) Applicant: Robert Bosch GmbH, Stuttgart (DE)

(72) Inventors: Ming Gao, Harsum (DE); Andreas Schmitt, Köln (DE); Oliver Roeth, Elze (DE)

(21) Appl. No.: 18/184,132

(22) Filed: Mar. 15, 2023

(30) Foreign Application Priority Data
Apr. 1, 2022 (DE) 10-2022-203264.0

(51) Int. Cl. G01C 21/00; G06F 16/29

(52) U.S. Cl. CPC G01C 21/3859; G06F 16/29; G01C 21/3822

(57) ABSTRACT

A method for creating map data having lane-specific resolution. Mapping data are initially received, the mapping data being transmitted by a vehicle, and including a vehicle trajectory and at least one object feature. Once the mapping data has been received, it is checked whether map data for local surroundings of the received mapping data are present. In the event the check indicates that no map data are present, map data are created from the mapping data and stored in a memory. In the event the check indicates that map data are already present, the map data are compared with the mapping data. If this comparison reveals that the mapping data differ from the map data, the map data are adapted, the adaptation taking place on the basis of a weighting factor. The adapted map data are subsequently stored in the memory.

### CROSS REFERENCE

The present application claims the benefit under 35 U.S.C. § 119 of German Patent Application No. DE 10 2022 203 264.0 filed on Apr. 1, 2022, which is expressly incorporated herein by reference in its entirety.

### FIELD

The present invention relates to a method for creating map data, and to a central processing unit for carrying out the method.

### BACKGROUND INFORMATION

Methods for creating map data are described in the related art, in which vehicle trajectories may be utilized in order to map negotiable roads for vehicles. The map data thus created may then be transferred, for example, with the aid of a radio link to vehicles and may be utilized in the vehicles for deploying vehicle navigation devices or for deployment in driver assistance systems. In such cases, it may be provided that the map data are lane-specific; this means that the number of traffic lanes and at which location traffic lanes for a road are present are stored in the map data. The map data, if they include a piece of information about a number and a position of traffic lanes, facilitate the route finding in driver assistance systems, in particular, if the driver assistance system is intended to enable a fully-automated movement of a vehicle.

The problem with this approach, however, may be when a real situation on a road does not correspond to the map data. This may present problems for driver assistance systems and render a reliable vehicle guidance impossible, in particular, when traffic lanes are omitted, for example, due to an obstacle such as, for example, a construction site or if traffic lanes are spatially shifted.

### SUMMARY

One object of the present invention is to provide a method for creating map data, in which on the one hand map data may be created from vehicle trajectories for those areas for which no map data are yet present and, on the other hand, deviations are detected for those areas for which map data are already present and an adaptation of the map data is able to take place. A further object of the present invention is to provide a central processing unit for carrying out the method.

These objects may be achieved with features of the present invention. Advantageous refinements of the present invention are disclosed herein.

In one method for creating map data having lane-specific resolution according to an example embodiment of the present invention, mapping data are initially received, the mapping data being transmitted by a vehicle and including a vehicle trajectory and at least one object feature. The vehicle trajectory in this case may include a sequence of vehicle coordinates, for example, provided with a time stamp. The vehicle coordinates may, for example, be two-dimensional or three-dimensional coordinates and may have been generated, in particular, with the aid of a satellite navigation system such as, for example, GPS or Galileo or may be determined, for example, with the aid of coupled navigation. The object feature may be a feature of an object at the edge of the roadway, above the roadway, next to the roadway or in a predefined arrangement relative to the roadway, ascertained, for example, with a further sensor independently of the vehicle trajectory. The object feature may, for example, be a characteristic of an object ascertained with the aid of radar sensor, a LIDAR sensor or with the aid of a camera recording.

Once the mapping data have been received, it is checked whether map data for local surroundings of the received mapping data are already present. In the event the check indicates that no map data are present, map data are created from the mapping data and stored in a memory. In the event the check indicates that map data are already present, the map data are compared with the mapping data. If this comparison reveals that the mapping data differ from the map data, the map data are adapted, the adaptation taking place based on a weighting factor. The adapted map data are subsequently stored in the memory.

According to an example embodiment of the present invention, it may be provided that the weighting factor is designed in such a way that the adaptation of the map data takes place, in particular, with respect to the object feature. The sensor system, with the aid of which the vehicle trajectory is ascertained, i.e., the satellite navigation data or coupled navigation data, may potentially be inaccurate to a relatively high degree. This inaccuracy is, in general, an absolute inaccuracy, the individual points of the vehicle trajectory relative to one another being relatively accurate. This means that, in general, should inaccuracies be present, the entire vehicle trajectory is shifted from a real situation by a predefined value. A correction may now take place with the aid of the object feature, since the ascertained object feature makes a spatial correction of the vehicle trajectory possible. If, for example, an object prominent relative to the traffic lane is stored in the memory with the aid of the object data, then it is possible when transmitting further map data to determine, in particular, the relative position of this object relative to the vehicle trajectory. Since prominent objects such as, for example, bridges, buildings, trees or other objects situated in the surroundings of a road are, in general, stationary, it is then possible to achieve a greater accuracy and, in particular, a lane-specific resolution.

According to an example embodiment of the present invention, the weighting factor in this case may thus include the newly transmitted vehicle trajectory being shifted relative to the map data on the basis of the object feature during the adaptation of the map data, until the object feature for the mapping data and for the previously stored map data matches and the position of the vehicle trajectory thus adapted is now used for the new or adapted map data.

In one specific embodiment of the method of the present invention, the creation of the map data from the mapping data takes place in such a way that mapping data of multiple vehicles are averaged and statistically evaluated. The creation of the map data takes place only when a predefined statistical accuracy of the averaged mapping data is present. This may be used, in particular, when no map data for the local surroundings of the received mapping data are yet present. In this case, a greater accuracy of the map data may be achieved in response to the transmission of the mapping data from multiple vehicles and with the aid of the averaging of these mapping data. In the process, it may, in particular, also be provided that the transmitted mapping data are initially evaluated with respect to one or to multiple object features and prominent objects, whose object data are transmitted from all vehicles, are assumed to be situated at the same location. The vehicle trajectories of the individual vehicles may be initially spatially shifted on the basis of these object data until the object data for all vehicles match, as a result of which the accuracy of the vehicle trajectories among one another may be increased and a more accurate representation of a real situation is achieved by the averaging of the vehicle trajectories.

In one specific embodiment of the present invention, the adaptation of the map data takes place in such a way that in the case of a deviation of the mapping data from the map data, a shift of a traffic lane by a predefined distance is recognized and the shift is taken into account when adapting the map data. The predefined distance in this case may be at least 50 centimeters. In this case as well, it may, in particular, be provided that the shifting of the traffic lane is recognized in that the transmitted vehicle trajectories are shifted in relation to one another on the basis of the object data, since it may be assumed that the object features themselves do not change even with a pivot of the traffic lane. For example, the lateral distance when passing under a bridge may be different in the case of a shifted traffic lane than in the case of a non-shifted traffic lane. Thus, if the traffic lane is shifted due to a construction site, it may be that the object feature: recognized bridge wall is recognized closer or further away relative to the vehicle and as a result, the shift of the traffic lane may be accordingly detected. This makes it possible to transfer map data including shifted traffic lanes to vehicles that include driver assistance systems, so that autonomous driving or automated execution of driving functions in this area becomes more readily possible.

In one specific embodiment of the present invention, the map data are created or adapted for a section of a map. The map data are linked at one edge of the section to an existing map. It may be provided, in particular, that in the event it is recognized that the map data have to be adapted, the edge of the section is selected in such a way that the complete shift of the roadway is situated within the section. Outside the section, the original map data may then be used for the map.

In one specific embodiment of the present invention, the weighting factor includes a first weighting factor element of the vehicle trajectory and a second weighting factor element of the object feature. The second weighting factor is greater than the first weighting factor element. This means, in particular, that the object features may be utilized in order to adapt a position of the individual vehicle trajectories relative to one another, since it may be assumed that the objects have not changed their spatial position relative to the coordinates and thus for all mapping data, the recognized objects must be situated, in principle, at an identical position. This allows for greater accuracy when creating or adapting the map data.

In one specific embodiment of the present invention, the vehicle trajectory includes waypoints determined with the aid of satellite navigation. Furthermore, the vehicle trajectory may include time stamps for the individual waypoints. The waypoints in this case may include, in particular, two-dimensional coordinates related to the degrees of longitude and latitude of the earth's surface.

Alternatively or in addition, the vehicle trajectory may include waypoints determined with the aid of coupled navigation.

In one specific embodiment of the present invention, the object feature includes a distance between an object and the vehicle determined using a sensor and a direction of the object relative to the vehicle determined using the sensor. Thus, the object feature may, for example, also include, at a particular position of the vehicle, a particular object having to be ascertained at a predefined distance and at a predefined angle. This may include, for example, a distance to a tunnel wall perpendicular to a driving direction or a distance to a prominent building perpendicular to a driving direction or at an arbitrary other angle relative to the driving direction. For each vehicle that moves in this area, it may be assumed that the object would have to be ascertained in this predefined distance and at this predefined angle. If deviations in the distance or in the angle result, it may be assumed that a vehicle trajectory is shifted. This may then either be confirmed already in the individual waypoints of the vehicle trajectory or it may be provided to carry out an adaption of the vehicle trajectory on basis of the weighting factor in order to create or to adapt the map data with the aid of the corrected vehicle trajectory.

In one specific embodiment of the present invention, the map data are transmitted to a vehicle. It may further be provided that at least one driving function in the vehicle is controlled on the basis of the map data. The driving function in this case may include, in particular, an autonomous driving, i.e., a full velocity control and steering-angle control of the vehicle. In this case, it is particularly advantageous to use lane-specific map data or adapted map data effected due to traffic lane shifts for the automated execution of the driving function.

A central processing unit includes a data interface, a memory and a processor. According to an example embodiment of the present invention, the processing unit is configured to receive mapping data from a vehicle via the data interface. The mapping data in this case include a vehicle trajectory and at least one object feature. The processor is configured to check whether map data for local surroundings of the received mapping data are already present. In the event the check indicates that no map data are present, the processor is configured to create map data from the mapping data and to store the map data in the memory. In the event the check indicates that map data are already present, the processor is configured to compare the map data with the mapping data and, in the event the comparison reveals that the mapping data differ from the map data, to adapt the map data. The adaptation in this case takes place based on a weighting factor. The processor is further configured to store the adapted map data in the memory.

The central processing unit is further configured to also implement in each case the specific embodiments further described in conjunction with the method for creating map data and to carry out corresponding method steps.

### BRIEF DESCRIPTION OF THE DRAWINGS

Exemplary embodiments of the present invention are explained on the basis of the figures.

FIG. 1 schematically shows a flowchart of a method for creating map data, according to an example embodiment of the present invention.

FIG. 2 schematically shows a road course, according to an example embodiment of the present invention.

FIG. 3 schematically shows the road course of FIG. 2 at another point in time.

FIG. 4 schematically shows a further representation of a road course, according to an example embodiment of the present invention.

### DETAILED DESCRIPTION OF EXAMPLE EMBODIMENTS

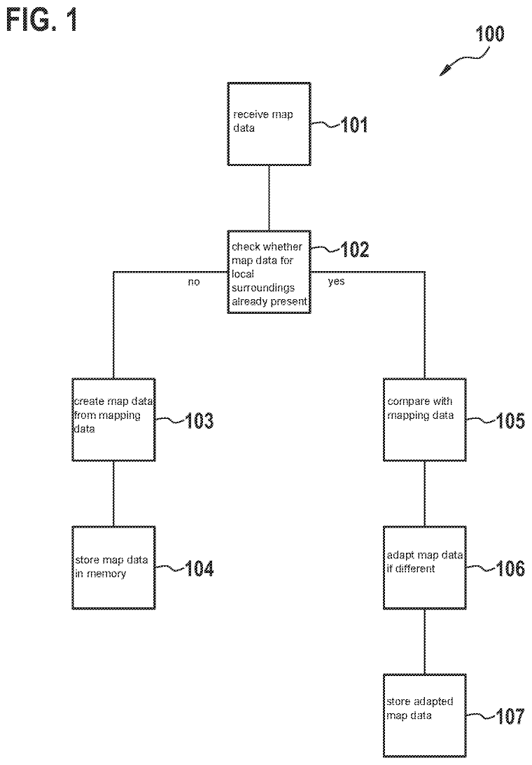

FIG. 1 shows a flowchart 100 of a method for creating map data having lane-specific resolution. In a receiving step 101, mapping data are received, which are transmitted by a vehicle. The mapping data include a vehicle trajectory and at least one object feature. The vehicle trajectories in this case may be consecutive points on a drive of a vehicle and may relate, for example, as two-dimensional or three-dimensional coordinates to a point of the earths' surface. The vehicle trajectory may be ascertained, for example, with the aid of a satellite navigation system. One further alternatively or additionally provided option for ascertaining the vehicle trajectory may be coupled navigation. The object feature may include a characteristic with respect to an object situated in the area of a road course or of a traffic lane.

In a check step 102, it is checked whether map data for local surroundings of the received mapping data are already present. If no map data are present as yet, i.e., the check indicates in check step 102 that no map data for the local surroundings are present, then map data are created from the mapping data in a creation step 103 and are subsequently stored in a memory in a storage step 104. If it is revealed in check step 102 that map data are already present, then the map data are compared with the mapping data in a comparison step 105. If the comparison of the map data with the mapping data in comparison step 105 reveals that the mapping data do not differ from the map data, then the method may be terminated and the receipt of the next mapping data in receiving step 101 may be awaited. In the event, however, it is revealed in comparison step 105 that the mapping data differ from the map data, an adaptation step 106 takes place, in which the map data are adapted. This adaptation takes place on the basis of a weighting factor, different values of vehicle trajectory and object feature being capable of being taken into account with the aid of the weighting factor. An alternative storage step 107 subsequently takes place, in which the adapted map data are stored in the memory.

The creation of the map data from the mapping data in creation step 103 may include recognizing a new, for example, branching traffic lane and connecting it to the existing map data with the non-branching traffic lane.

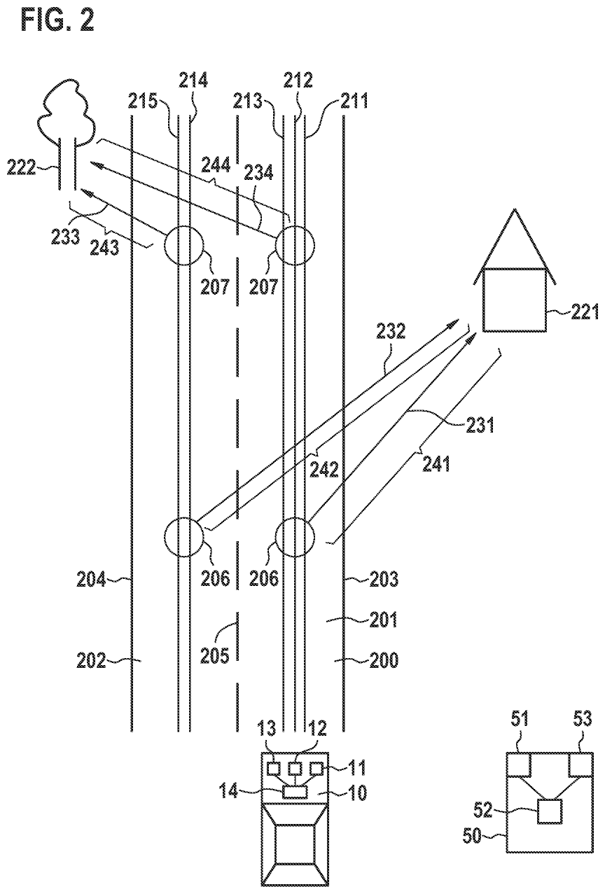

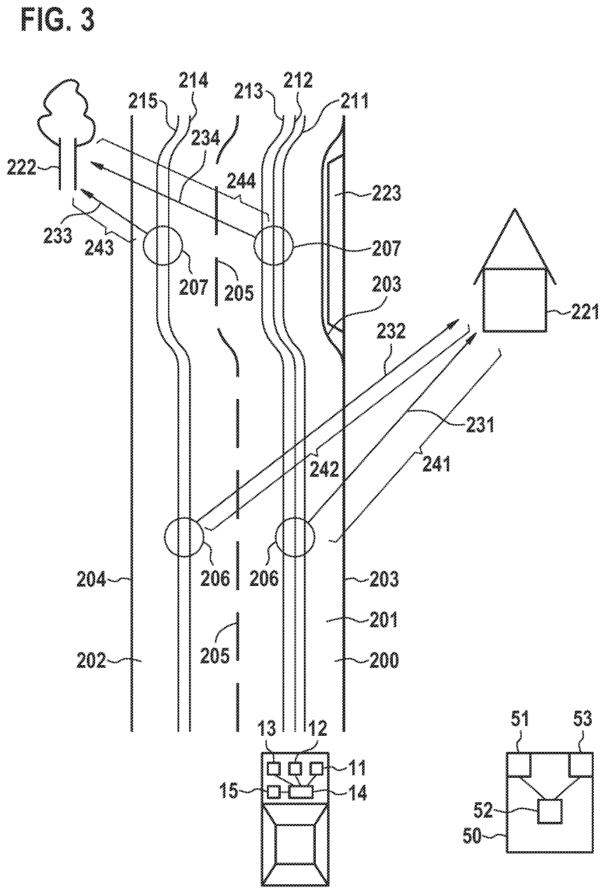

The individual method steps of flowchart 100 are now explained in greater detail in conjunction with FIGS. 2 and 3.

FIG. 2 shows a road course 200 including a first traffic lane 201 and a second traffic lane 202. A first road boundary line 203 delimits first traffic lane 201. A second road boundary line 204 delimits second traffic lane 202. A center line 205 is situated between traffic lanes 201, 202.

A vehicle 10 is situated in the area of road course 200, vehicle including a first sensor 11, a second sensor 12, a third sensor 13 as well as a vehicle interface 14. First sensor 11 in this case may be provided for ascertaining a vehicle trajectory of vehicle 10. Thus, first sensor 11 is able to record a vehicle trajectory of vehicle 10, the vehicle trajectory being able to include, for example, coordinates of vehicle 10 at various points in time. First sensor 11 may, for example, include a receiver for a satellite navigation system such as GPS, Galileo and/or GLONASS. First sensor 11 may further include an acceleration sensor and a rotation sensor and may thus be suitable for determining a vehicle trajectory with the aid of coupling navigation. First sensor 11 may also include in both cases the electronics necessary for the respective sensor. Second sensor 12 may be configured to determine an object feature. Third sensor 13 is optional and may also be used for ascertaining an object feature. Second sensor 12 and/or third sensor 13 in this case may include cameras, RADAR sensors and/or LIDAR sensors and the electronics necessary for evaluating the signals. The vehicle trajectory recorded with the aid of first sensor 11 and the object features recorded with the aid of second sensor 12 and, optionally, of third sensor 13 may be conveyed to a central processing unit 50 with the aid of vehicle interface 14. Central processing unit 50 in this case includes a data interface 51, a processor 52 as well as a memory 53. Processor 52 may be configured in this case to carry out the method steps explained in conjunction with FIG. 1. Vehicle interface 14 in this case may include, in particular, a transmitter for emitting and a receiver for receiving digital data. The same applies to data interface 51.

A first vehicle trajectory 211, a second vehicle trajectory 212 as well as third vehicle trajectory 213 are plotted on first traffic lane 201 of FIG. 2. These vehicle trajectories may, for example, have been transmitted to central processing unit 50 from vehicles that have already passed road course 200. If vehicle 10 now negotiates, for example, first traffic lane 201, then a further vehicle trajectory similar to first vehicle trajectory 211, to second vehicle trajectory 212 or to third vehicle trajectory 213 may be recorded. As shown in FIG. 2, first vehicle trajectory 211, second vehicle trajectory 212 as well as third vehicle trajectory 213 potentially differ in this case from one another. This may, for example, be due to the fact that different vehicles 10 are guided differently by vehicle drivers over road course 200 and the exact coordinates of vehicle trajectories 211, 212, 213 may potentially differ from one another. On second traffic lane 202, a fourth vehicle trajectory 214 and a fifth vehicle trajectory 215 are plotted, which are also slightly different. A first object 221, represented as a building, and a second object 222, represented as a tree, are further shown in the area of road course 200. Objects 221, 222 may be utilized in order to achieve a more accurate mapping of traffic lanes 201, 202. For this purpose, it is provided at particular points of first traffic lane 201 or of second traffic lane 202 to ascertain an object feature of first object 221 or of second object 222. The object feature of first object 221 in this case may include, for example, a first direction 231 from a predefined area 206 of first traffic lane 201 to first object 221. Alternatively or in addition, the object may include a first distance 241 from predefined area 206 of first traffic lane 201 to first object 221. First direction 231 and/or first distance 241 in this case may be ascertained with the aid of second sensor 12 and/or of third sensor 13. Second sensor 12 in this case may be a radar sensor or LIDAR sensor and may provide a run-time measurement of a radar pulse or of a laser pulse for determining first distance 241 and a location resolution of the backscattered radar pulse or laser pulse for ascertaining first direction 231. For a predefined area 206 of second traffic lane 202, a second direction 232 having a second distance 242 to first object 221 may also be evaluated.

In the process, it may be provided that vehicle trajectories 211, 212, 213 may be adapted on the basis of first direction 231 and/or of first distance 241. First object 221 is generally stationary relative to first traffic lane 201, so that a vehicle located in predefined area 206 of first traffic lane 201 will ascertain first direction 231 or first distance 241 to first object 221. In this way, a calibration of the measured data of first vehicle trajectory 211, of second vehicle trajectory 212 and/or of third vehicle trajectory 213 may take place. This is useful, in particular, because vehicle trajectories ascertained with the aid of satellite navigation or coupled navigation exhibit a relatively high degree of accuracy of the individual points relative to one another, however, an absolute accuracy is not necessarily guaranteed. Via the comparison with the object data (here, first direction 231 or first distance 241) it is possible to increase the accuracy. The same applies to fourth vehicle trajectory 214 and fifth vehicle trajectory 215 in predefined area 206 of second traffic lane 202, here, second direction 232 or second distance 242 to first object 221 being able to be evaluated and utilized.

A further predefined area 207 of first traffic lane 201 is situated on first traffic lane 201 in the area of second object 222. A further predefined area 207 of second traffic lane 202 is also situated on second traffic lane 202. An object feature, now of second object 222, may be recorded in further predefined area 207 of second traffic lane 202 and in the process a third direction 233 or a third distance 243 may be evaluated similarly to the above-described approach. The same applies to further predefined area 207 of first traffic lane 201 with respect to a fourth direction 234 and to a fourth distance 244.

When creating the map data in creation step 103, it may be provided, for example, that the creation of the map data from the mapping data takes place in such a way that mapping data of multiple vehicles 10 are averaged and statistically evaluated. The creation of the map data takes place only when a predefined statistical accuracy of the averaged mapping data is present. This may be the case in FIG. 2, for example, when vehicle 10 has negotiated first traffic lane 201 and a further vehicle trajectory of first traffic lane 201 has been recorded as a result.

Together with first vehicle trajectory 211, second vehicle trajectory 212 and third trajectory 213 already present, a sufficient statistical accuracy may now be potentially present, so that an averaging of vehicle trajectories 211, 212, 213 then present as well as the vehicle trajectory of vehicle 10 to be newly recorded allow for a mapping and a storage in the memory of first traffic lane 201. Two further vehicles 10 would then have to be moved on second traffic lane 202 in order to achieve an identical statistical accuracy. In this case, it may be provided, in particular, that in the predefined areas 206 or in further provided areas 207, an adaptation of the vehicle trajectories on the basis of the object features, i.e., of directions 231, 232, 233, 234 and of distances 241, 242, 243, 244 to respective object 221, 222 is utilized in order to correspondingly adapt vehicle trajectories 211, 212, 213, 214, 215.

FIG. 3 shows road course 200 of FIG. 2 at a later point in time. An obstacle 223 is now situated on first traffic lane 201, which may, for example, be part of a construction site or of another obstacle, which results in a traffic lane pivot. Thus, in the area of obstacle 223, first road boundary line 203 as well as center line 205 are correspondingly shifted. Vehicles that negotiate road course 200 in this area also exhibit a trajectory pivot necessary due to the traffic lane pivot, so that first vehicle trajectory 211, second vehicle trajectory 212, third vehicle trajectory 213, fourth vehicle trajectory 214 and fifth vehicle trajectory 215 are also pivoted here. Further predefined areas 207 are also located in the area of the traffic lane pivots, so that in the area of further predefined areas 207, the object features of second object 222, i.e., in particular, third direction 233 and fourth direction 234 as well as third distance 243 and fourth distance 244 differ accordingly from the representation of FIG. 2. Both the deviation of the object features of second object 222 and the deviation of vehicle trajectories 211, 212, 213, 214, 215 may be recognized in comparison step 105. Furthermore, an adaptation of the map data and thus an adaptation of the pieces of information about first traffic lane 201 and second traffic lane 202 stored in memory 53 may now take place in adaptation step 106 on the basis of the mapping data. This takes place on the basis of a weighting factor. In this case, it may, for example, be provided, in particular, that if a predefined area 206 and/or a further predefined area 207 is/are situated in the area of the deviating mapping data, the object data of associated first object 221 or 222 (in FIG. 3 only of object 222) are weighted more heavily than altered vehicle trajectories 211, 212, 213, 214, 215. It may, for example, be provided, in particular, that a shift of first traffic lane 201 or of second traffic lane 202 by a predefined distance, for example, by at least 50 centimeters, is recognized, in particular, with the aid of an evaluation of the object data.

Instead of objects 221, 222 represented in FIGS. 2 and 3, further objects having different directions may also be evaluated such as, for example, tunnel walls, bridge walls or building walls extending in parallel to road course 200. It may further be provided that the weighting factor includes a first weighting factor element of vehicle trajectories 211, 212, 213, 214, 215 and a second weighting factor element of the object feature of objects 221, 222. The second weighting factor element in this case may be greater than the first weighting factor element. It may, for example, be provided, in particular, that a changed object feature may be incorporated weighted at 70 to 90 percent into the adaptation of traffic lanes 201, 202, whereas a changed vehicle trajectory is incorporated only up to 30 to 10 percent into adapted traffic lanes 201, 202. For example, a weighting of 80 percent to 20 percent may be provided, i.e., that a changed object feature is incorporated weighted at 80 percent into the adaptation of traffic lanes 201, 202, whereas a changed vehicle trajectory is incorporated only up to 20 percent into adapted traffic lanes 201, 202.

Vehicle 10 further optionally includes a device 15 for the automated execution of a driving function. The map data stored in memory 53 may also be transferred via data interface 51 and vehicle interface 14 to vehicle 10. Device 15 may be configured to control at least one driving function on the basis of the map data. This may include, in particular, a longitudinal and transverse guidance of vehicle 10 and thus include a velocity control and a steering control of vehicle 10.

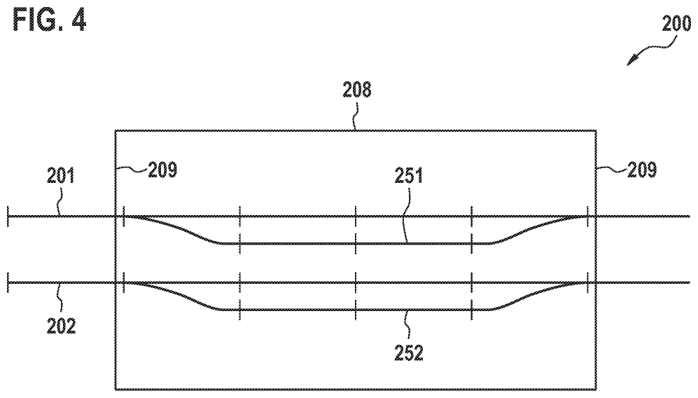

FIG. 4 schematically shows a view of a further road course 200 including a first traffic lane 201 and a second traffic lane 202. Map data are adapted in one section 208, because in this section 208, a pivoted first traffic lane 251 and a pivoted second traffic lane 252 have been detected using the methods explained in conjunction with FIGS. 2 and 3. The map data are linked at edges 209 of section 208 to an existing map made up of first traffic lane 201 and second traffic lane 202. In other words, this means, therefore, that section 208 is selected in such a way that pivoted traffic lanes 251, 252 are situated within section 208 and traffic lanes 201, 202 outside section 208 are not pivoted. Similarly, this methodology may also not be applied in adaptation step 106, but rather in creation step 103 if no map data are present yet in section 208.

Although the present invention has been described in detail via the preferred exemplary embodiments, the present invention is not restricted to the described examples and other variations may be inferred therefrom by those skilled in the art without departing from the scope of protection of the present invention.

What is claimed is:

1. A method for creating map data having lane-specific resolution, comprising the following steps:
receiving mapping data, transmitted by a vehicle, the mapping data including a vehicle trajectory and at least one object feature;
checking whether map data for local surroundings of the received mapping data are already present;
based on the check indicating that no map data are present, creating map data from the mapping data and storing the map data in a memory;
based on the check indicating that map data are present:
comparing the map data with the mapping data;
based on the comparison revealing that the mapping data differ from the map data: (i) adapting the map data, the adaptation taking place based on a weighting factor, and storing the adapted map data in the memory.

2. The method as recited in claim 1, wherein the creation of map data from the mapping data takes place in such a way that mapping data of multiple vehicles are averaged and are statistically evaluated, the creation of the map data taking place only when a predefined statistical accuracy of the averaged mapping data is present.

3. The method as recited in claim 1, wherein the adaptation of the map data takes place in such a way that in the case of a deviation of the mapping data from the map data, a shift of a traffic lane by a predefined distance is recognized and the shift is taken into account when adapting the map data.

4. The method as recited in claim 3, wherein the predefined distance is at least 50 centimeters.

5. The method as recited in claim 1, wherein the map data is created or adapted for a section of a map, the map data being linked at an edge of the section to an existing map.

6. The method as recited in claim 1, wherein the weighting factor includes a first weighting factor element of the vehicle trajectory and a second weighting factor element of the object feature, and the second weighting factor element being greater than the first weighting factor element.

7. The method as recited in claim 1, wherein the vehicle trajectory includes waypoints determined using satellite navigation.

8. The method as recited in claim 1, wherein the object feature includes a distance between an object and the vehicle determined using a sensor and a direction of the object relative to the vehicle determined using the sensor.

9. The method as recited in claim 1, wherein the map data are further transmitted to a vehicle and at least one driving function in the vehicle is controlled based on the map data.

10. A central processing unit, comprising:
a data interface;
a memory; and
a processor;
the central processing unit being configured to receive mapping data from a vehicle via the data interface, the mapping data including a vehicle trajectory, and the processor being configured to check whether map data for local surroundings of the received mapping data are already present, and, in the event the check indicates that no map data are present, to create map data from the mapping data and to store the map data in the memory, and, in the event the check indicates that map data are present, to compare the map data with the mapping data and, in the event the comparison reveals that the mapping data differ from the map data, to adapt the map data, the adaptation taking place based on a weighting factor, and to store the adapted map data in the memory.
